(19) United States
(12) Patent Application Publication
(10) Pub. No.: US 2024/0222635 A1
(43) Pub. Date: Jul. 4, 2024

(54) FLUOROPOLYMER BINDER

(71) Applicant: Arkema France, Colombes (FR)

(72) Inventors: Anthony BONNET, Colombes (FR); Thomas FINE, Colombes (FR)

(21) Appl. No.: 18/558,551

(22) PCT Filed: May 2, 2022
(86) PCT No.: PCT/FR2022/050845

§ 371 Date: Nov. 2, 2023

(30) Foreign Application Priority Data
May 3, 2021 (FR) 2104641

(51) Int. Cl. H01M 4/62; H01M 4/04; H01M 4/66; H01M 10/0525; H01M 4/02

(52) U.S. Cl. CPC H01M 4/623; H01M 4/0404; H01M 4/624; H01M 4/661; H01M 10/0525; H01M 2004/021; H01M 2004/027; H01M 2004/028

(57) ABSTRACT

The present invention relates generally to the field of electrical energy storage in secondary batteries of Li-ion type. More specifically, the invention relates to a binder in the form of a powder based on a homogeneous mixture of fluoropolymers. The invention also relates to a number of processes for preparing said binder. Lastly, the invention relates to an electrode comprising said binder, and also to Li-ion secondary batteries comprising at least one such electrode.

### FIELD OF THE INVENTION

The present invention relates generally to the field of electrical energy storage in secondary batteries of Li-ion type. More specifically, the invention relates to a binder in the form of a powder based on an intimate mixture of fluoropolymers. The invention also relates to a number of processes for preparing said binder. Lastly, the invention relates to an electrode comprising said binder, and also to energy storage devices comprising at least one such electrode, such as Li-ion secondary batteries and supercapacitors.

### TECHNICAL BACKGROUND

A Li-ion battery comprises at least one negative electrode or anode coupled to a copper current collector, a positive electrode or cathode coupled to an aluminium current collector, a separator and an electrolyte. The electrolyte consists of a lithium salt, generally lithium hexafluorophosphate, mixed with a solvent that is a mixture of organic carbonates, which are selected in order to optimize ion transportation and dissociation. A high dielectric constant favours ion dissociation, and thus the number of ions available in a given volume, whereas a low viscosity favours ion diffusion, which plays a key role, among other parameters, in the rates of charge and discharge of the electrochemical system.

For their part, the electrodes generally comprise at least one current collector on which is deposited, in the form of a film, a composite material consisting of: a material termed active because it exhibits electrochemical activity towards lithium, a polymer that acts as binder, plus one or more electrically conductive additives that are generally carbon black or acetylene black, and optionally a surfactant.

Binders are counted among the so-called inactive components, because they do not contribute directly to the capacity of the cells. However, their key role in the treatment of the electrodes and their considerable influence on the electrochemical performance of electrodes have been widely described. The principal relevant physical and chemical properties of binders are: thermal stability, chemical and electrochemical stability, tensile strength (strong adhesion and cohesion) and flexibility. The main purpose of using a binder is to form stable networks of the solid components of the electrodes, that is to say the active materials and the conductive agents (cohesion). In addition, the binder must ensure close contact between the composite electrode and the current collector (adhesion).

Polyvinylidene fluoride (PVDF) is the binder most commonly used in lithium-ion batteries on account of its excellent electrochemical stability, good adhesion capacity and strong adhesion to the materials of the electrodes and of the current collectors. However, PVDF can be dissolved only in certain organic solvents such as N-methylpyrrolidone (NMP), which is volatile, flammable, explosive and highly toxic, causing serious environmental problems. The use of organic solvents requires significant investment in production, recycling and purification facilities.

Compared to the conventional method of producing electrodes in a wet suspension, dry (solvent-free) production processes are simpler; such processes eliminate the emission of volatile organic compounds and offer the possibility of producing electrodes having greater thicknesses (>120 μm), with a higher energy density in the final energy storage device.

Polytetrafluoroethylene (PTFE) is a material of choice for dry electrode production, because of its ability to fibrillate at ambient temperature. Fibrillation of PTFE improves the mechanical properties of the electrode and increases its cohesion. PTFE nevertheless has two limitations: it does not always permit development of an adequate level of adhesion to the cathode (on aluminium foil) and it needs to be combined with other binders; PTFE undergoes a reduction reaction at the anode, which severely limits its use.

WO 2015/161289 describes an energy storage device having a cathode, an anode and a separator between the anode and cathode, wherein at least one of the electrodes comprises a composite binder material based on polytetrafluoroethylene (PTFE). The PTFE composite binder material may comprise PTFE and at least one of the following materials: polyvinylidene fluoride (PVDF) and a copolymer of PVDF and polyethylene oxide (PEO). Example 6 describes a production process for forming the cathode electrode film, said process comprising first mixing activated carbon with powdered PVDF in a 2:1 mass ratio for 10 minutes, followed by a step of comminution by spraying at a pressure of about 80 psi, then adding a blended powder comprising NMC, activated carbon and carbon black, and finally adding the PTFE and mixing for 10 minutes.

The disadvantage of this type of composite binder is the lack of lasting cohesion, i.e. even if a homogeneous initial mixture of more than one type of particle is obtained, these particles are not attached to one other and are therefore subject to settling phenomena during storage or transport, and thus to a loss of homogeneity over time.

There remains the need to develop novel electrode binders for Li-ion batteries that are suitable for dry (solvent-free) electrode production.

It is therefore an object of the invention to provide compositions and methods of production for binders and films based on solid particles, for use in battery electrodes.

Another object of the present invention is to provide an electrode that has a relatively low content by mass of binder in order to make it possible to increase the content of active filler in the cathode in order to maximize battery capacity.

The invention is also intended to provide a production process for an electrode for a Li-ion battery employing said compositions, by a solvent-free deposition technique on a metal substrate. The invention lastly relates to an electrode obtained by this process.

Lastly, the invention is intended to provide energy storage devices comprising at least one such electrode, such as Li-ion secondary batteries and supercapacitors comprising at least one such electrode.

### SUMMARY OF THE INVENTION

The present invention relates to a binder employable in a lithium-ion battery. It is a composite binder formed from an intimate mixture of two fluoropolymers: PTFE and PVDF.

The invention firstly relates to a fluoropolymer binder for a lithium-ion battery, consisting of a mixture of a PTFE phase formed from particles of PTFE having a size ranging from 10 nm to 1 μm and a PVDF phase formed from particles of PVDF having a size ranging from 10 nm to 1 μm, said binder being in the form of a powder.

According to one embodiment, the PVDF is selected from polyvinylidene fluoride homopolymers or copolymers of vinylidene difluoride with at least one comonomer selected from the list: vinyl fluoride, tetrafluoroethylene, hexafluoropropylene, 3,3,3-trifluoropropene, 2,3,3,3-tetrafluoropropene, 1,3,3,3-tetrafluoropropene, hexafluoroisobutylene, perfluorobutylethylene, 1,1,3,3,3-pentafluoropropene, 1,2,3,3,3-pentafluoropropene, perfluoro(propyl vinyl ether), perfluoro(methyl vinyl ether), bromotrifluoroethylene, chlorofluoroethylene, chlorotrifluoroethylene, chlorotrifluoropropene, ethylene and mixtures thereof.

The invention also relates to various processes for producing said binder.

According to one embodiment, said binder is prepared by co-spraying of PVDF latex and PTFE latex, the process comprising the following steps:
a. mixing a PVDF latex with a PTFE latex,
b. adding water to the PVDF latex/PTFE latex mixture to bring the dry extract to a polymer content of between 10% and 50% by weight,
c. co-spraying the mixture thus obtained so as to obtain a composite powder formed from particles of PTFE and particles of PVDF.

According to one embodiment, said binder is prepared by polymerization of PVDF in the presence of a seeding of PTFE.

According to one embodiment, said binder is prepared by polymerization of PTFE in the presence of a seeding of PVDF.

The invention also provides a Li-ion battery electrode comprising an active filler for anode or cathode, an electrically conductive filler and a fluoropolymer binder as described above. The applicant has demonstrated that it is possible to produce electrodes for lithium-ion batteries that have a content by mass of binder equal to or greater than 1% and equal to or less than 5%; this represents a lesser amount of binder than a technique that does not permit the two types of binder to be intimately combined, this being reflected by the need to increase the amount of binder to be used in order to achieve equivalent handling, flexibility and adhesion properties. Reducing the amount of binder makes it possible to increase the content of active filler in the cathode and to thus increase the charging capacity of the latter.

The invention also relates to a solvent-free process for producing a Li-ion battery electrode. The invention also provides a Li-ion secondary battery comprising a negative electrode, a positive electrode and a separator, in which at least one electrode is as described above.

The present invention makes it possible to overcome the disadvantages of the state of the art. More particularly, it provides a technology that makes it possible to:
improve the ability of the electrode material to be handled, for a lower content of binder in the electrode;
control the distribution of the binder and of the conductive filler on the surface of the active filler;
ensure the cohesion and the mechanical integrity of the electrode by guaranteeing good film formation or consolidation of the formulations, which can be difficult to achieve for solvent-free processes;
improve the homogeneity of the composition of the electrode in the electrode thickness and width;
reduce the overall content of binder in the electrode, which, in the case of the known solvent-free processes, remains greater than that of a standard slurry process;
improve the mechanical strength of self-supporting films of electrode formulations. This means that when the solvent-free electrode production process proceeds via an intermediate phase of production of a self-supporting film of the formulation prior to assembly on the current collector, the formulation makes it possible to attain mechanical behaviour sufficient for the handling and winding/unwinding phases.

### DESCRIPTION OF EMBODIMENTS OF THE INVENTION

The invention is now described in more detail and in a nonlimiting way in the description that follows.

According to a first aspect, the invention relates to a fluoropolymer binder for a lithium-ion battery, consisting of a mixture of a polytetrafluoroethylene (PTFE) phase and a polyvinylidene fluoride (PVDF) phase.

Said binder is characteristically in the form of a powder consisting of a mixture of PTFE primary particles having a size ranging from 10 nm to 1 μm and PVDF primary particles having a size ranging from 10 nm to 1 μm.

According to various embodiments, said electrode comprises the features below, in combination where appropriate. The stated contents are expressed by weight, unless otherwise stated.

According to one embodiment, said PTFE particles have a size ranging from 50 nm to 500 nm and preferably ranging from 100 nm to 300 nm.

According to one embodiment, said PVDF particles have a size ranging from 50 nm to 500 nm and preferably ranging from 100 nm to 300 nm.

The primary particles are defined here as being the particles having a size of less than 1 μm.

The size of the polymer particles is expressed as the volume mean diameter (Dv50). The Dv50 is the particle diameter at the 50th percentile of the cumulative particle size distribution. This parameter may be measured by laser particle size analysis.

The mass ratio in the binder between PVDF and PTFE varies from 10:90 to 90:10.

According to one embodiment, the binder is fibrillatable on account of the presence of the PTFE.

### PVDF

The fluoropolymer used in the invention generally referred to by the abbreviation PVDF is a polymer based on vinylidene difluoride.

According to one embodiment, the PVDF is a polyvinylidene fluoride homopolymer or a mixture of vinylidene fluoride homopolymers.

According to one embodiment, the PVDF is a polyvinylidene fluoride homopolymer or a copolymer of vinylidene difluoride with at least one comonomer compatible with vinylidene difluoride.

The comonomers compatible with vinylidene difluoride may be halogenated (fluorinated, chlorinated or brominated) or non-halogenated.

Examples of appropriate fluorinated comonomers are: vinyl fluoride, tetrafluoroethylene, hexafluoropropylene, trifluoropropenes and in particular 3,3,3-trifluoropropene, tetrafluoropropenes and in particular 2,3,3,3-tetrafluoropropene or 1,3,3,3-tetrafluoropropene, hexafluoroisobutylene, perfluorobutylethylene, pentafluoropropenes and in particular 1,1,3,3,3-pentafluoropropene or 1,2,3,3,3-pentafluoropropene, perfluorinated alkyl vinyl ethers and in particular those of general formula Rf-O—CF═CF₂, Rf being an alkyl group, preferably a C₁ to C₄ alkyl group (preferred examples being perfluoro(propyl vinyl ether) and perfluoro(methyl vinyl ether)).

The fluorinated comonomer may contain a chlorine or bromine atom. It may in particular be selected from bromotrifluoroethylene, chlorofluoroethylene, chlorotrifluoroethylene and chlorotrifluoropropene. Chlorofluoroethylene can denote either 1-chloro-1-fluoroethylene or 1-chloro-2-fluoroethylene. The 1-chloro-1-fluoroethylene isomer is preferred. Chlorotrifluoropropene is preferably 1-chloro-3,3,3-trifluoropropene or 2-chloro-3,3,3-trifluoropropene.

The VDF copolymer may also comprise non-halogenated monomers such as ethylene and/or acrylic or methacrylic comonomers.

The fluoropolymer preferably contains at least 50 mol % of vinylidene difluoride.

According to one embodiment, the PVDF is a copolymer of vinylidene fluoride (VDF) and hexafluoropropylene (HFP) (P(VDF-HFP)), having a percentage by weight of hexafluoropropylene monomer units of from 2% to 23%, preferably from 4% to 15% by weight, relative to the weight of the copolymer.

According to one embodiment, the PVDF is a mixture of a polyvinylidene fluoride homopolymer and a VDF-HFP copolymer.

According to one embodiment, the PVDF is a copolymer of vinylidene fluoride and tetrafluoroethylene (TFE).

According to one embodiment, the PVDF is a copolymer of vinylidene fluoride and chlorotrifluoroethylene (CTFE).

According to one embodiment, the PVDF is a VDF-TFE-HFP terpolymer. According to one embodiment, the PVDF is a VDF-TrFE-TFE terpolymer (TrFE being trifluoroethylene). In these terpolymers, the content by mass of VDF is at least 10%, the comonomers being present in variable proportions.

According to one embodiment, the PVDF is a copolymer of two or more VDF-HFP copolymers.

According to one embodiment, the PVDF comprises monomer units bearing at least one of the following functions: carboxylic acid, carboxylic acid anhydride, carboxylic acid esters, epoxy groups (such as glycidyl), amide, hydroxyl, carbonyl, mercapto, sulfide, oxazoline, phenolic, ester, ether, siloxane, sulfonic, sulfuric, phosphoric or phosphonic. The function is introduced by a chemical reaction that can be grafting or a copolymerization of the fluorinated monomer with a monomer bearing at least one of said functional groups and a vinyl function capable of copolymerizing with the fluorinated monomer, according to techniques well known to those skilled in the art.

According to one embodiment, the functional group bears a carboxylic acid function that is a group of (meth)acrylic acid type selected from acrylic acid, methacrylic acid, hydroxyethyl (meth)acrylate, hydroxypropyl (meth)acrylate and hydroxyethylhexyl (meth)acrylate.

According to one embodiment, the units bearing the carboxylic acid function additionally contain a heteroatom selected from oxygen, sulfur, nitrogen and phosphorus.

According to one embodiment, the functionality is introduced by means of the transfer agent used during the synthesis process. The transfer agent is a polymer of molar mass less than or equal to 20 000 g/mol and bearing functional groups selected from the groups: carboxylic acid, carboxylic acid anhydride, carboxylic acid esters, epoxy groups (such as glycidyl), amide, hydroxyl, carbonyl, mercapto, sulfide, oxazoline, phenolic, ester, ether, siloxane, sulfonic, sulfuric, phosphoric or phosphonic. An example of a transfer agent of this type is oligomers of acrylic acid.

The content of functional groups in the PVDF is at least 0.01 mol %, preferably at least 0.1 mol %, and at most 15 mol %, preferably at most 10 mol %.

The PVDF preferably has a high molecular weight. The term “high molecular weight”, as used here, is understood as meaning a PVDF having a melt viscosity of greater than 100 Pa·s, preferably of greater than 500 Pa·s, more preferably of greater than 1000 Pa·s, advantageously of greater than 2000 Pa·s. The viscosity is measured at 232° C., at a shear gradient of 100 s⁻¹, using a capillary rheometer or a parallel-plate rheometer in accordance with standard ASTM D3825. The two methods give similar results.

The PVDF homopolymers and VDF copolymers used in the invention can be obtained by known polymerization methods, such as emulsion polymerization.

According to one embodiment, they are prepared by an emulsion polymerization process in the absence of a fluorinated surface-active agent.

The polymerization of the PVDF results in a latex generally having a solids content of from 10% to 60% by weight, preferably from 10% to 50%, and having a weight-average particle size of less than 1 micrometre, preferably less than 1000 nm, preferably less than 800 nm and more preferably less than 600 nm. The weight-average size of the particles is generally at least 10 nm, preferably at least 50 nm, and advantageously the average size is within a range from 100 to 400 nm. The polymer particles may form agglomerates, referred to as secondary particles, the weight-average size of which is less than 5000 μm, preferably less than 1000 μm, advantageously between 1 and 80 micrometres and preferably from 2 to 50 micrometres. The agglomerates may break up into discrete particles during formulation and application to a substrate.

According to some embodiments, the PVDF homopolymer and the VDF copolymers are composed of biobased VDF. The term “biobased” means “resulting from biomass”. This makes it possible to improve the ecological footprint of the membrane. Biobased VDF can be characterized by a content of renewable carbon, that is to say of carbon of natural origin and originating from a biomaterial or from biomass, of at least 1 atom %, as determined by the content of 14° C. in accordance with standard NF EN 16640. The term “renewable carbon” indicates that the carbon is of natural origin and originates from a biomaterial (or from biomass), as indicated hereinbelow. According to some embodiments, the biocarbon content of the VDF may be greater than 5%, preferably greater than 10%, preferably greater than 25%, preferably greater than or equal to 33%, preferably greater than 50%, preferably greater than or equal to 66%, preferably greater than 75%, preferably greater than 90%, preferably greater than 95%, preferably greater than 98%, preferably greater than 99%, advantageously equal to 100%.

### PTFE

The fluoropolymer used in the invention generally referred to by the abbreviation PTFE is a polymer based on tetrafluoroethylene (TFE).

According to one embodiment, the PTFE is a poly(tetrafluoroethylene) homopolymer or a mixture of tetrafluoroethylene homopolymers.

According to one embodiment, the PTFE is a poly(tetrafluoroethylene) homopolymer or a copolymer of tetrafluoroethylene with at least one comonomer compatible with tetrafluoroethylene, such as vinylidene fluoride or hexafluoropropylene.

According to one embodiment, the polytetrafluoroethylene used in the binder composition according to the invention, as a mixture with PVDF, is a polymer obtained by emulsion polymerization of TFE under the conditions known to those skilled in the art.

According to one embodiment, the TFE may be copolymerized with at least one other monomer, such as vinylidene fluoride or hexafluoropropylene.

The polymerization of the PTFE results in a latex generally having a solids content of from 10% to 60% by weight, preferably from 10% to 50%, and having a weight-average particle size of less than 1 micrometre, preferably less than 1000 nm, preferably less than 800 nm and more preferably less than 600 nm. The weight-average size of the particles is generally at least 10 nm, preferably at least 50 nm, and advantageously the average size is within a range from 100 to 400 nm.

According to one embodiment, the PTFE used in the invention has a high molecular weight, preferably of greater than 100 000 g/mol.

The invention also relates to various processes for producing the fluoropolymer binder.

### Co-Spraying

According to one embodiment, said binder is prepared by co-spraying of the PVDF latex and PTFE latex described above.

The spraying (or co-spraying) is known per se. For a general description of this technology, see for example the chapter “Drying” by P. Y. McCormick in “Encyclopedia of Polymer Science and Engineering”, volume 5, pp. 187-203, Wiley Intersciences, 1990. During the preparation of the binder in powder form, the fluoropolymers are always in the form of particles of less than 1 μm in size.

According to one embodiment, an aqueous dispersion is prepared by mixing while stirring the mixture of fluorinated polymer latex (PVDF latex and PTFE latex as described above) so as to bring the dry extract to a content of between 10% and 50% by mass of the polymers PVDF+PTFE. This aqueous dispersion is then sprayed, preferably in the presence of a defoamer agent of the modified siloxane polyether type, in order to result in a composite powder that can then be used in the preparation of the electrodes.

On completion of the powder production step, the particle size can be adjusted and optimized by selection or screening methods.

### Polymerization of PVDF in the Presence of a Seeding of PTFE (PVDF Shell/PTFE Core)

According to one embodiment, said binder is prepared by polymerization of PVDF in the presence of a seeding of PTFE.

According to one embodiment, water is added to the reactor used for the emulsion polymerization of the TFE monomers and for obtaining the PTFE in latex form so as to obtain a dry extract ranging from 10% to 50%, to which is added the vinylidene fluoride and a polymerization initiator. At the end of the polymerization reaction, a stable latex is obtained that has a particle size within a range from 200 to 400 nm (Dv50). The PVDF:PTFE composition by mass of this latex varies from 10:90 to 90:10. The solids content obtained is between 10 and 60%.

According to one embodiment, the PTFE latex is obtained in a first reactor, which is transferred to a second reactor, optionally after a period of storage, after which the polymerization of the PVDF is commenced.

### Polymerization of PTFE in the Presence of a Seeding of PVDF (PTFE Shell/PVDF Core)

According to one embodiment, said binder is prepared by polymerization of PTFE in the presence of a seeding of PVDF.

According to one embodiment, water is added to the reactor used for the emulsion polymerization of the VDF monomers and for obtaining the PVDF in latex form so as to obtain a dry extract ranging from 10% to 50%, to which is added the tetrafluoroethylene and a polymerization initiator. At the end of the polymerization reaction, a stable latex is obtained that has a particle size within a range from 200 to 400 nm (Dv50). The PVDF:PTFE composition by mass of this latex varies from 10:90 to 90:10. The solids content obtained is between 10 and 60%.

According to one embodiment, the PVDF latex is obtained in a first reactor, which is transferred to a second reactor, optionally after a period of storage, after which the polymerization of the PTFE is commenced.

The invention also provides a Li-ion battery electrode comprising an active filler for anode or cathode, an electrically conductive filler and a fluoropolymer binder as described above.

In the electrode material, the PTFE is fibrillated. The extent of fibrillation and the quality of the fibrils formed influence certain properties of the electrode, such as its flexibility and manipulability. The fibrils are visible by scanning electron microscopy (SEM).

The active materials at the negative electrode are generally lithium metal, graphite, graphene, silicon/carbon composites, silicon, fluorographites of CFₓ type where x is between 0 and 1 and titanates of LiTi₅O₁₂ type.

The active materials at the positive electrode are generally of the LiMO₂ type, of the LiMPO₄ type, of the Li₂MPO₃F type, of the Li₂MSiO₄ type where M is Co, Ni, Mn, Fe or a combination of these, of the LiMn₂O₄ type, of the S₈ type or of the lithium polysulfide type represented by the formula Li₂Sn where n>1.

The conductive fillers are selected from carbon blacks, graphites, natural or synthetic, carbon fibres, carbon nanotubes, metal fibres and powders, and conductive metal oxides. They are preferably selected from carbon blacks, graphites, natural or synthetic, carbon fibres and carbon nanotubes.

A mixture of these conductive fillers may also be produced. In particular, the use of carbon nanotubes in combination with another conductive filler such as carbon black can have the advantages of reducing the content of conductive fillers in the electrode and of reducing the content of polymeric binder content on account of a lower specific surface area compared to carbon black.

According to one embodiment, a polymeric dispersant that is different to said binder is used in a mixture with the conductive filler in order to break up the agglomerates present and to aid the dispersion thereof in the final formulation with the polymeric binder and the active filler. The polymeric dispersant is selected from poly(vinylpyrrolidone), poly(phenylacetylene), poly(meta-phenylene vinylidene), polypyrrole, poly(para-phenylene benzobisoxazole), poly(vinyl alcohol) and mixtures thereof.

The composition by mass of the electrode is:
50% to 99% of active filler, preferably from 50% to 99%,
25% to 0.05% of conductive filler, preferably from 25% to 0.5%,
10% to 0.5% of polymeric binder, preferably from 6% to 1%,
0% to 5% of at least one additive selected from the list: plasticizer, ionic liquid, dispersant for the conductive fillers and flow agent for the formulation,
   the sum of all these percentages being 100%.

The invention also relates to a solvent-free process for producing a Li-ion battery electrode, said process comprising the following steps:
mixing the active filler, the polymeric binder, the conductive filler and any additives by means of a process that makes it possible to obtain an electrode formulation that can be applied to a metal support by a solvent-free process;
depositing said electrode formulation on the metal substrate by a “solvent-free” process so as to obtain a Li-ion battery electrode and
consolidating said electrode by a heat treatment (application of a temperature ranging up to 50° C. above the melting temperature of the polymer, without mechanical pressure) and/or thermomechanical treatment such as calendering or thermocompression.

A “solvent-free” process is understood as meaning a process in which there is no need for a step of evaporation of residual solvent downstream of the deposition step.

Another embodiment of the process for producing an electrode comprises the following steps:
mixing the active filler, the polymeric binder and the conductive filler by means of a process that makes it possible to obtain an electrode formulation, the constituents of which are mixed homogeneously;
producing a self-supporting film of the formulation by means of a thermomechanical process such as extrusion, calendering or thermocompression;
depositing the self-supporting film on the metal substrate by a calendering or thermocompression process and
consolidating said electrode by a heat treatment and/or thermomechanical treatment such as calendering for example, this final step being an option when the preceding step already achieves a sufficient level of adhesion and/or porosity.

Solvent-free mixing processes for the various constituents of the electrode formulation include, without this being an exhaustive list: mixing by agitation, air-jet mixing, high-shear mixing, mixing with a V-mixer, mixing with a screw mixer, double-cone mixing, drum mixing, conical mixing, double Z-arm mixing, mixing in a fluidized bed, mixing in a planetary mixer, mixing by mechanofusion, mixing by extrusion, mixing by calendering, mixing by milling.

Other mixing processes include mixing options that employ a liquid such as water, for example spray drying (co-spraying) or a process of spraying a liquid containing the binder and/or the conductive filler onto a fluidized powder bed of the active filler.

The metal supports of the electrodes are generally made of aluminium for the cathode and of copper for the anode. The metal supports may be surface-treated and have a conductive primer with a thickness of 5 μm or more. The supports may also be carbon fibre woven or nonwoven fabrics.

The consolidation of said electrode is effected by a heat treatment, by passage through an oven, under an infrared lamp, through a calender with heated rollers or through a press with heated plates. Another alternative consists of a two-step process.

First of all, the electrode is subjected to a heat treatment in an oven, under an infrared lamp or by contact with heated plates without pressure. A step of compression at ambient or elevated temperature is then carried out by means of a calender or a plate press. This step makes it possible to adjust the porosity of the electrode and to improve adhesion on the metal substrate.

The invention also relates to a Li-ion battery electrode produced by the process described above.

According to one embodiment, said electrode is an anode.

According to one embodiment, said electrode is a cathode.

The invention also provides a Li-ion secondary battery comprising a negative electrode, a positive electrode and a separator, in which at least one electrode is as described above.

The invention also provides a supercapacitor comprising at least one such electrode.

### Examples

The following examples illustrate the scope of the invention in a non-limiting manner.

### Sample 1—Preparation of a PTFE Latex

Into a reactor are introduced water, an initiator, a chain-transfer agent, a non-fluorinated emulsifier and ethylene tetrafluoride. The polymerization is carried out at a temperature of 68° C. and under a pressure of 3000 kPa. After 180 min, a latex having a solids content of 29% is obtained. The size of the primary particles is 250 nm (D50).

### Sample 2—Preparation of a PTFE Powder

The latex of sample 1 is then spray-dried to obtain a PTFE powder.

### Sample 3—Preparation of a PVDF Latex

Into a reactor are introduced water, an initiator, a chain-transfer agent, a non-fluorinated emulsifier and vinylidene fluoride. The polymerization is carried out at a temperature of 85° C. and under a pressure of 9000 kPa. After 180 min, a latex having a solids content of 37% is obtained. The size of the primary particles is 225 nm (D50).

### Sample 4—Preparation of a PVDF Powder

The latex corresponding to sample 3 is spray-dried to obtain a PVDF powder.

### Sample 5—Preparation of a Mixture of PVDF and PTFE Powders

Into a Henschel FM10 powder mixer are introduced over a period of 2 minutes 750 g of PTFE powder corresponding to sample 2 and 250 g of PVDF powder corresponding to sample 4. The mixture is stirred for 2 min at a speed of rotation such that the speed at the tip of the paddles is 20 m·s⁻¹.

### Sample 6—Preparation of a PTFE/PVDF Composite Binder by Co-Spraying

The PTFE latex corresponding to sample 1 (1.034 kg), the PVDF latex corresponding to sample 3 (0.27 kg) and 0.696 kg of water are mixed so as to adjust the dry extract to a content of 20% of PVDF+PTFE polymer. A defoamer product (Byk 019) is also added. The addition is carried out under moderate stirring in a 5 container (10 rpm) and at an ambient temperature of 20° C. The aqueous dispersion obtained is readily pumpable. The PTFE latex/PVDF latex mixture thus prepared is then pumped under moderate stirring (10 rpm) and co-sprayed employing the following operating conditions:
Inlet temperature of co-sprayer: 175° C.
Outlet temperature of co-sprayer: 55° C.
Compressed air: 220 kPa

Co-spraying of the PVDF latex particles and the PTFE latex particles allows the preparation of 400 g of PVDF/PTFE composite powder. This composite powder contains 25% by mass of PVDF and 75% by mass of PTFE. The size of the secondary particles thus formed is 23 μm (D50).

### Sample 7—Preparation of a Core-Shell Structure, PTFE Core/PVDF Shell

Into a reactor are introduced water, an initiator, a chain-transfer agent, a non-fluorinated emulsifier and ethylene tetrafluoride. The polymerization is carried out at a temperature of 68° C. and under a pressure of 3000 kPa. The total reaction volume is 21. After 180 min, a latex having a solids content of 29% is obtained. The latex thus obtained is then adjusted to a 20% dry extract by addition of water (900 g). The temperature is then increased to 90° C. and the pressure is increased to 4500 kPa by continuous addition of VF2 to the reactor. Addition of potassium persulfate initiator initiates the polymerization of a PVDF shell around the PTFE core. After polymerizing for 60 minutes, a stable latex having a particle size of 280 nm (D50) is obtained. The composition by mass is 75% PTFE and 25% PVDF. The solids content obtained is 25%. The total amount of VF2 consumed is 193 g.

### Sample 8—Preparation of a Core-Shell Structure, PVDF Core/PTFE Shell

Into a reactor are introduced water, an initiator, a chain-transfer agent, a non-fluorinated emulsifier and PVDF. The polymerization is carried out at a temperature of 90° C. and under a pressure of 4500 kPa. The total reaction volume is 2 l. After 180 min, a latex having a solids content of 37% is obtained, in which the size of the primary particles D50 is 225 nm. The latex thus obtained is then adjusted to a 15% dry extract by addition of water (2933 g). The temperature is then lowered to 70° C. and the pressure is lowered to 3000 kPa by continuous addition of TFE to the reactor. Addition of potassium persulfate initiator initiates the polymerization of a PTFE shell around the PVDF core. After polymerizing for 200 minutes, a stable latex having a particle size of 338 nm (D50) is obtained. The composition by mass is 75% PTFE and 25% PVDF. The solids content obtained is 37.5%.

Standard electrode formulation: Active material, conductive filler such as carbon black (but also graphene, carbon nanotubes, vapour-grown carbon fibre (VGCF)) and PVDF binder

### Electrode Production Process

The active material binder/conductive filler mixture is produced in two steps. Firstly, an active filler is mixed with a conductive filler by a solvent-free process. In a second step, the binder is mixed with the active filler+conductive filler premix. As a solvent-free mixing process for the various constituents of the formulation, a Henschel FM10 high-speed paddle mixer was employed for 2 minutes at a speed of rotation such that the speed at the tip of the paddles is 20 m·s⁻¹. The composition is then prepared in the form of a self-supporting film by compression using a press with heated parallel plates. This is done by depositing the formulation on a siliconized film so as to obtain a grammage of 25 mg/cm². A second film of siliconized paper is then deposited on the surface of the deposit. The assembly consisting of the first layer of siliconized paper, the formulation and the second layer of siliconized paper is then compressed at 200° C. under 700 kPa for 5 minutes. After the compression step, the assembly is removed from the press and allowed to cool to ambient temperature. After removing the siliconized paper layers, a self-supporting film is obtained. In a second step, the self-supporting film is pressed onto the aluminium current collector under the same conditions as in the production of the self-supporting film.

The conditions for the preparation of the films and of the final cathode were adjusted so as to obtain a thickness of 75 μm and a porosity of 32-34%, calculated indirectly according to the basis weight based on the theoretical weight per unit surface area.

### Measurement of Film Manipulability

An elongation at break test is carried out on the film and a classification is made to determine the manipulability thereof. The classification ranges from HO (immediate rupture) to H3 (elongation at break greater than 3%).

### Measurement of Adhesion

180° peel test performed with a dynamometer using cut-out test specimens 15 cm long and 25 mm wide. A double-sided adhesive is used to evaluate the peel force. One side of the adhesive is glued onto the electrode and the other side is glued onto a rigid metal support having a thickness of a few millimetres. The rigid support is fixed in the lower jaw of the dynamometer, with the end of the electrode fixed in the upper jaw of the dynamometer. The peel force is determined by pulling at a rate of the order of 100 to 200 mm/min. This permits the establishment of the classification below—the values are just a guide, since they depend on the measuring device, peel force, peel rate and adhesive supplier.

The classification ranges from A0 (no adhesion) to A4 (excellent adhesion).

### Measurement of Flexibility—Empirical Test (Described in Document US 2002/0168569)

Test specimens 5 cm long and at least 2 cm wide are cut out of the electrodes. These specimens are then wrapped around or bent over a metal bar 1 mm in diameter. The surface is then visually observed to identify any cracks and to establish the classification below.

The classification ranges from F0 (very poor flexibility) to F4 (excellent flexibility).

TABLE 1

| | | | PTFE/PVDF | PTFE/PVDF | | | | | | | |
|---|---|---|---|---|---|---|---|---|---|---|---|
| | | | powder | powder | | | | | Electrode properties | | |
| | | | 75:25 | 75:25 | PTFE/PVDF | | | | | Adhesion | |
| | PTFE | PVDF | (premixing | (co-spraying | powder 75:25 core- | | | | | to | |
| | powder | powder | of powders) | of latex) | shell structure type | | | | Manipulation | current | |
| | Sample | Sample | Sample | Sample | Sample 7 | Sample 8 | Conductive | Active | of film | collector | Flexibility |
| Cathode | 2 | 4 | 5 | 6 | PVDF shell | PTFE shell | agent | material | H0-H3 | A0-A4 | F0-F4 |
| Counter- | 1.50% | | | | | | 1.5% | 97.0% | H2 | A0 | F0 |
| example 1 | | | | | | | | | | | |
| Counter- | | 1.50% | | | | | 1.5% | 97.0% | H0 | A1 | F1 |
| example 2 | | | | | | | | | | | |
| Counter- | 1.13% | 0.38% | | | | | 1.5% | 97.0% | H1 | A1 | F1 |
| example 3 | | | | | | | | | | | |
| Counter- | | | 1.50% | | | | 1.5% | 97.0% | H1 | A1 | F1 |
| example 4 | | | | | | | | | | | |
| Counter- | 2.25% | 0.75% | | | | | 3.0% | 94.0% | H2 | A2 | F2 |
| example 5 | | | | | | | | | | | |
| Counter- | | | 3.00% | | | | 3.0% | 94.0% | H2 | A2 | F2 |
| example 6 | | | | | | | | | | | |
| Counter- | 3.75% | 1.25% | | | | | 5.0% | 90.0% | H3 | A4 | F4 |
| example 7 | | | | | | | | | | | |
| Example 1 | | | | 1.50% | | | 1.5% | 97.0% | H1 | A1 | F2 |
| Example 2 | | | | | 1.50% | | 1.5% | 97.0% | H1 | A2 | F2 |
| Example 3 | | | | | | 1.50% | 1.5% | 97.0% | H1 | A2 | F2 |
| Example 4 | | | | 3.00% | | | 3.0% | 94.0% | H3 | A4 | F4 |
| Example 5 | | | | | 3.00% | | 3.0% | 94.0% | H3 | A4 | F4 |
| Example 6 | | | | | | 3.00% | 3.0% | 94.0% | H3 | A3 | F4 |
| Example 7 | | | | 5.00% | | | 5.0% | 90.0% | H3 | A4 | F4 |
| Example 8 | | | | | 5.00% | | 5.0% | 90.0% | H3 | A4 | F4 |
| Example 9 | | | | | | 5.00% | 5.0% | 90.0% | H3 | A4 | F4 |

1. A lithium-ion battery binder consisting of a mixture of a polytetrafluoroethylene (PTFE) phase formed from primary particles of PTFE having a size ranging from 10 nm to 1 μm and a polyvinylidene fluoride (PVDF) phase formed from primary particles of PVDF having a size ranging from 10 nm to 1 μm, said binder being in the form of a powder.

2. The lithium-ion battery binder of claim 1, wherein the PTFE particles have a size ranging from 50 nm to 500 nm.

3. The lithium-ion battery binder of claim 1, wherein the PVDF particles have a size ranging from 50 nm to 500 nm.

4. The lithium-ion battery binder of claim 1, wherein the PVDF is selected from polyvinylidene fluoride homopolymers or copolymers of vinylidene difluoride with at least one comonomer selected from the group consisting of: vinyl fluoride, tetrafluoroethylene, hexafluoropropylene, 3,3,3-trifluoropropene, 2,3,3,3-tetrafluoropropene, 1,3,3,3-tetrafluoropropene, hexafluoroisobutylene, perfluorobutylethylene, 1,1,3,3,3-pentafluoropropene, 1,2,3,3,3-pentafluoropropene, perfluoro(propyl vinyl ether), perfluoro(methyl vinyl ether), bromotrifluoroethylene, chlorofluoroethylene, chlorotrifluoroethylene, chlorotrifluoropropene, ethylene and mixtures thereof.

5. A process for producing the binder of claim 1, comprising said process comprising the following steps:
a. mixing a PVDF latex with a PTFE latex to form a PVDF latex/PTFE latex mixture,
b. adding water to the PVDF latex/PTFE latex mixture to bring the polymer content of to between 10% and 50% by weight,
c. co-spraying the PVDF latex/PTFE latex mixture obtained in step b to obtain a composite powder formed from particles of PTFE and particles of PVDF.

6. A process for producing the binder according to claim 1, by polymerization of PVDF in the presence of a seeding of PTFE.

7. A process for producing the binder according to claim 1, by polymerization of PTFE in the presence of a seeding of PVDF.

8. A Li-ion battery electrode comprising an active filler for anode or cathode, an electrically conductive filler and the lithium-ion battery binder of claim 1.

9. The Li-ion battery electrode of claim 8, wherein the electrode is a negative electrode, wherein said active filler is selected from lithium metal, graphite, silicon/carbon composites, silicon, graphene, fluorographites of CFx type where x is between 0 and 1, and titanates of LiTi₅O₁₂ type.

10. The Li-ion battery electrode of to claim 8, wherein the electrode is a positive electrode, wherein said active filler is selected from active materials of the LiMO₂ type, of the LiMPO₄ type, of the Li₂MPO₃F type, of the Li₂MSiO₄ type where M is Co, Ni, Mn, Fe or a combination of these, of the LiMn₂O₄ type, of the S₈ type or of the lithium polysulfide type represented by the formula Li₂Sₙ where n>1; for a positive electrode.

11. The Li-ion battery electrode of claim 8, wherein the conductive fillers are selected from the group consisting of carbon blacks, natural or synthetic graphites, carbon fibres, carbon nanotubes, metal fibres and powders, conductive metal oxides or mixtures thereof.

12. The Li-ion battery electrode of claim 8 having the following composition by mass:
50% to 99% of active filler
25% to 0.05% of conductive filler,
10% to 0.5% of polymeric binder,
0% to 5% of at least one additive selected from the group consisting of: plasticizer, ionic liquid, dispersant for the conductive fillers and flow agent for the formulation,
the sum of all these percentages being 100%.

13. A process for producing the Li-ion battery electrode of claim 8, said process comprising the steps of:
mixing the active filler, the polymeric binder and the conductive filler by means of a process that makes it possible to obtain an electrode formulation that can be applied to a metal support by a solvent-free process;
depositing said electrode formulation on the metal substrate by a solvent-free process so as to obtain a Li-ion battery electrode and
consolidating said electrode by a heat treatment and/or thermomechanical treatment.

14. A secondary Li-ion battery comprising an anode, a cathode and a separator, wherein at least one of the electrodes comprises the Li-ion battery electrode of claim 8.

15. A supercapacitor comprising at least one electrode according to claim 8.
